(19) United States
(12) Patent Application Publication
(10) Pub. No.: US 2011/0094085 A1
(43) Pub. Date: Apr. 28, 2011

(54) METHOD FOR PRODUCING CONTOUR STRIP

(75) Inventors: Takeshi Sakurai, Aizuwakamatsu-shi (JP); Shunroku Sukumoda, Aizuwakamatsu-shi (JP); Shinya Koike, Aizuwakamatsu-shi (JP)

(73) Assignee: Mitsubishi Shindoh Co., Ltd., Tokyo (JP)

(21) Appl. No.: 12/736,785

(22) PCT Filed: May 20, 2009
(86) PCT No.: PCT/JP2009/002216

§ 371 Date: Nov. 9, 2010

(30) Foreign Application Priority Data
May 23, 2008 (JP) 2008-135987 2008

(51) Int. Cl. B23P 17/00

(52) U.S. Cl. 29/527.1

(57) ABSTRACT

A method for producing a contour strip includes a rough rolling step for rolling a plate material to form a contour molding material, a slitting step for slitting the contour molding material at the middle position in the width direction of a thick portion or a thin portion at both side edge portions thereof to form a contour slit material, and a stretching step for stretching the contour slit material to obtain a contour strip. Rolling is carried out in the rough rolling step so that Δt is 0.01 or less, e is 0.15 or less, D1 is 0.4 or less, and a rough rolling management value X determined by Δt×e×D1 is 5×10⁻⁴ or less, assuming the deviation of plate thickness at a thin portion from a target value is Δt (mm), an actual measurement of the radius of curvature at a corner formed by the side surface and the top surface of a tick portion is e (mm), and an actual measurement of curvature per meter-length of the contour molding material is D1 (mm), the contour molding material is cut in the slitting step so that an actual measurement |A−B| (mm) of the difference in the width from the side edge of the thick portion or thin portion between both side edge portions is 0.08 or less, and the contour slit material is stretched in the stretching step so that an actual measurement D2 (mm) of curvature per meter-length of the contour molding strip is 0.13 or less.

### TECHNICAL FIELD

The present invention relates to a method for producing a contour strip where thick and thin portions are formed to be lined up in a width direction.

### BACKGROUND ART

As is well known, a contour strip made of metal is used for a lead frame of, for example, a LED, a power transistor, or the like.

As techniques for producing the contour strip, there are a molding technique using a plate die and a roller and a molding technique using a grooved roller and a flat roller as described in PTL 1 and 2.

In a technique disclosed in PTL 1, there is provided a pressing roller that faces the surface of a plate die. The pressing roller rolls and presses a long plate material, which is provided on the surface of the plate die, within a range corresponding to the surface of the plate die. By moving the plate material to the rear side from the front end of the die by a predetermined length, the pressing roller produces a contour strip each time the pressing and rolling movement is completed.

Further, in a technique disclosed in PTL 2, a flat roller having a constant roller radius and a grooved roller, which includes a plurality of roller portions of which roller radii vary in the direction of an axis, are disposed parallel to an axis so as to be close to each other; roll a plate material inserted into a gap formed between the flat roller and the grooved roller; and form thin portions at the plate material in the longitudinal direction by the respective roller. Accordingly, a contour strip is produced.

Since the thickness of each of these contour strips varies in the width direction, distortion is generated, so that the contour strips are apt to be deformed. For this reason, as described in PTL 3 to 5, annealing or stretching is performed on the molding material having a deformed cross-section to improve a dimensional accuracy.

In a technique disclosed in PTL 3, a first rolling mill, which pulls and shapes a formed long metal plate, is provided on the rear side of a die device, which includes a plate die and a pressing roller, with an intermittent feeding and absorbing device interposed therebetween. A degreasing device and a continuous annealing furnace are provided on the rear side of the first rolling mill. A second rolling mill and a slit cutter disposed close to the second rolling mill are provided on the rear side of the degreasing device and the continuous annealing furnace. While a long metal plate molded by the die device is being moved at a constant speed as it is by the intermittent movement of a metal material, shaping, annealing, and width working are continuously performed.

In a technique disclosed in PTL 4, a metal plate having a deformed cross-section is clamped by clamps and distortion is stretched by the pulling of the metal plate in the longitudinal direction. The clamp is formed of a plurality of divided plates that is divided in a direction crossing the pulling direction of the metal plate, and a clamping force is controlled according to the material and shape of the metal plate.

A technique disclosed in PTL 5 is a method for stretching a contour strip including clamping a contour strip at different positions in the longitudinal direction by clamping tools, and applying a tensile force to the contour strip by moving the clamping tools so that a gap between the clamping tools is increased. The clamping tools are rotated according to the deformation of the contour strip that is caused by pulling.

### CITATION LIST

[PTL 1] JP-A-52-36512
[PTL 2] JP-A-2003-71052
[PTL 3] JP-A-6-285573
[PTL 4] JP-A-63-97311
[PTL 5] Japanese Patent No. 3341610

### SUMMARY OF INVENTION

### Technical Problem

However, since a strip has a deformed cross-section, it may not be possible to avoid the generation of distortion during molding and there is a demand for a technique that further improves the accuracy regarding the shape and dimensions.

The invention has been made in consideration of the above-mentioned circumstances, and an object of the invention is to provide a method for producing a contour strip of which accuracy can be further improved.

### Solution to Problem

According to an embodiment of the invention, there is provided a method for producing a contour strip. The method includes a rough rolling step for rolling a plate material to form a contour molding material where thick and thin portions are lined up in a width direction, a slitting step for slitting the contour molding material in a longitudinal direction at the middle position in the width direction of the thick portion or the thin portion disposed at the both side edge portions thereof and slitting off the both side edge portions to form a contour slit material, and a stretching step for stretching the contour slit material to obtain a contour strip. Rolling is carried out in the rough rolling step so that Δt is 0.01 or less, e is 0.15 or less, D1 is 0.4 or less, and a rough rolling management value X determined by Δt×e×D1 is 5×10⁻⁴ or less, assuming that the deviation of plate-thickness at the thin portion from a target value is Δt (mm), an actual measurement of the radius of curvature at a corner formed by the side surface and the top surface of the tick portion is e (mm), and an actual measurement of curvature per meter-length of the contour molding material is D1 (mm). The contour molding material is slit in the slitting step so that |A−B| is 0.08 or less assuming that an actual measurement of the difference in the width from the side edge of the thick portion or the thin portion disposed at the both side edge portions is |A−B| (mm). The deformed cross-section slit material is stretched in the stretching step so that D2 is 0.13 or less assuming that an actual measurement of curvature per meter-length of the contour strip is D2 (mm).

Further, in the method according to the embodiment of the invention, the contour strip may be produced so that the product (X×Y×Z) of a rough rolling management value X, a slitting management value Y, and a stretching-management value Z is 6×10⁻⁶ or less assuming that |A−B| measured in the slitting step is the slitting management value Y and D2 measured in the stretching step is the stretching-management value Z.

Furthermore, in the method according to the embodiment of the invention, in the rough rolling step, the plate material may be intermittently fed in the longitudinal direction by a die that includes a molding surface for forming the thick and thin portions and a rolling roller that is reciprocated in the longitudinal direction of the molding surface of the die between a position facing the molding surface of the die and a position deviated from the molding surface of the die, when the rolling roller is positioned at the position deviated from the molding surface of the die, and the plate material may be interposed between the rolling roller and the molding surface of the die and may be rolled when the rolling roller is positioned at a position facing the molding surface of the die.

Furthermore, in the method according to the embodiment of the invention, in the rough rolling step, brake members, which come into contact with the plate material at the upstream position of the die, may be pressed and apply a braking friction force to the plate material while the contour molding material is wound at a constant speed at the downstream position of the die by a winding mechanism, and the contour molding material may be pulled while being bent by pressing an oscillation roller, which comes into contact with the other surface of the contour molding material by a spring while one surface of the contour molding material is supported by support rollers between the die and the winding mechanism.

In this case, assuming that the natural frequency of the oscillation roller, which is pressed by the spring, is f1 and the frequency of the rolling roller is f2, a spring constant of the spring may be determined so that f1 exceeds f2 and is equal to or smaller than two times of f2.

Moreover, in the method according to the embodiment of the invention, in the rough rolling step, the plate material may be interposed and rolled between a grooved roller on which small-diameter roller portions for forming the thick portions and large-diameter roller portions for forming the thin portions are formed to be lined up in the direction of an axis, and a flat roller that has a constant radius in the direction of an axis.

In this case, the grooved roller may be formed so that wide large-diameter roller portions and narrow large-diameter roller portions narrower than the wide large-diameter roller portions are formed to be lined up with small-diameter roller portions interposed therebetween, the diameter of the wide large-diameter roller portion is larger than that of the narrow large-diameter roller portion, and Δr/h is in the range of 0.01 to 0.5 assuming that a difference between the radii of both the large-diameter roller portions is Δr and a difference between the radii of the narrow large-diameter roller portion and the small-diameter roller portion is h.

Further, in the method according to the embodiment of the invention, in the slitting step, tension may be controlled by pressing the respective contour slit materials between the winding mechanism and the slitter while the respective contour slit materials separated by the slitter are wound at a constant speed by the winding mechanism.

Furthermore, in the method according to the embodiment of the invention, in the stretching step, the stretched contour strip may be wound at a constant speed by a winding mechanism while the contour slit material is fed at a constant speed by a feed mechanism. In addition, while slack portions are formed at the contour slit material and the contour strip between the feed mechanism and the winding mechanism, the contour slit material may be clamped by elastic members between both slack portions so that tension is applied to the contour slit material.

### ADVANTAGEOUS EFFECTS OF INVENTION

According to the method of the invention, it may be possible to produce a contour strip that includes thick portions and thin portions and has accurate dimensions and an accurate shape.

### BRIEF DESCRIPTION OF THE DRAWINGS

FIG. 1 is a schematic view showing the structure of a rough rolling device that is used in a rough rolling step of a first embodiment of the invention.

FIG. 2 is a front view of a rolling roller and a die of a rolling mill of the rough rolling device shown in FIG. 1.

FIG. 3 is a plan view of a molding surface of the die of the rolling mill shown in FIG. 2.

FIG. 4 is a graph showing the temporal changes in a tensile load F that is applied to a deformed cross-section molding material by the rough rolling device of FIG. 1, and shows two kinds where a spring constant of a speed adjusting mechanism is changed.

FIG. 5 is a cross-sectional view showing that molding is carried out by the rolling mill of FIG. 2.

FIG. 6 is a plan view illustrating the bend of the contour molding material that is formed by the rough rolling device of FIG. 1.

FIG. 7 is a schematic view showing the structure of a slitting device that is used in a slitting step of the first embodiment of the invention.

FIG. 8 is a schematic view showing the structure of a stretching device that is used in a stretching step of the first embodiment of the invention.

FIG. 9 is a cross-sectional view showing that a contour slit material is clamped by clamp members of the stretching device of FIG. 8.

FIG. 10 is a cross-sectional view of a contour strip that is produced by a method according to the first embodiment of the invention.

FIG. 11 is a schematic view showing the structure of a rough rolling device that is used in a rough rolling step of a second embodiment of the invention.

FIG. 12 is a schematic perspective view showing the structure of main portions of a rolling mill of the rough rolling device shown in FIG. 11.

FIG. 13 is a cross-sectional view of a part of a grooved roller of the rolling mill shown in FIG. 12 taken along the direction of an axis P2 of the grooved roller.

FIG. 14 is an enlarged cross-sectional view of main portions that are represented by H in FIG. 13.

FIG. 15 is a cross-sectional view showing that the rolling mill of FIG. 12 is rolling a plate material M.

FIG. 16 is a view showing the thickness distribution of a thin portion of a contour molding material formed by the rolling mill of FIG. 12 in the width direction, in which a square plot represents a thin portion formed by a second large-diameter roller portion and a rhombic plot represents a thin portion formed by a constant-radius roller portion in the related art.

FIG. 17 is a cross-sectional view showing an example of modification of the shape of the outer peripheral surface of the second large-diameter roller portion.

FIG. 18 is a cross-sectional view of a contour strip that is produced by a method according to the second embodiment of the invention.

### DESCRIPTION OF EMBODIMENTS

An embodiment in which a method for producing a contour strip according to the invention is applied to the production of a contour strip made of a copper alloy will be described below.

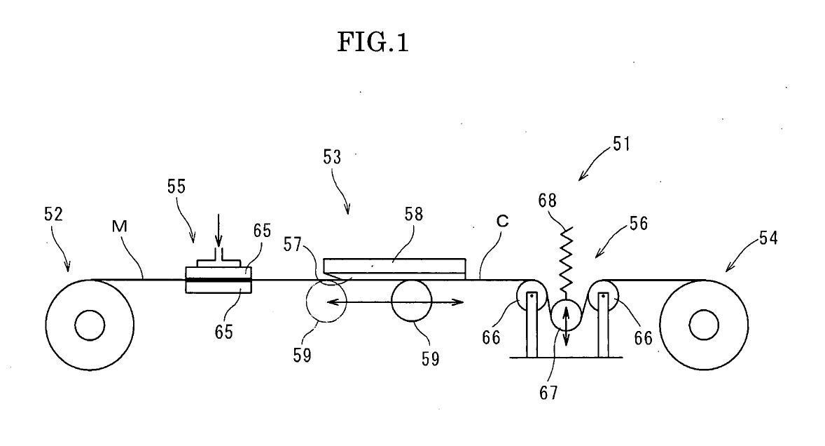

FIGS. 1 to 10 are views illustrating a production method according to a first embodiment of the invention.

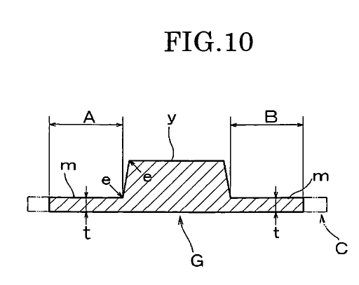

FIG. 10 is a view showing a contour strip E that is finally obtained. The contour strip E is formed in a shape where thin portions m having the same width (A=B) are formed on both sides of a thick portion y, both side surfaces of the thick portion y are slightly inclined, and the width of the thick portion y is gradually decreased in a height direction. Further, target values of the plate thicknesses of both the thin portions m are set to the same thickness t. The radius e of curvature at a corner that is formed between the upper surface of each thin portion m and each side surface of the thick portion y, and the radius e of curvature at a corner that is formed between each side surface and the top surface of the thick portion y are also set to the same target value.

A method for producing the contour strip E according to a first embodiment includes a rough rolling step for rolling a plate material M to form a contour molding material C where thick and thin portions y and m are lined up in a width direction; an annealing step for annealing the contour molding material C; a finishing rolling step for carrying out finishing rolling on the annealed contour molding material C; a slitting step for slitting the thin portions m of the contour molding material C, which has been subjected to the finishing rolling, in a longitudinal direction by a slitter to separate a contour slit material E where thin portions m are formed on both sides of a thick portion y; and a stretching step for stretching the warpage of the contour slit material E to obtain a target contour strip G.

The plate material M is obtained by forming a ductile material in the shape of a plate, and is made of a copper alloy of, for example, Cu-0.1% Fe-0.03% P.

Meanwhile, the plate material is worked in the respective steps, so that the shapes, dimensions, and the like of the thick and thin portions are changed. However, in this specification, for convenience of description, the thick and thin portions are denoted by the same reference characters, that is, the thick portion is denoted by y and the thin portion is denoted by m in the respective steps.

The respective steps of the method for producing the contour strip will be described in detail below.

### <Rough Rolling Step>

A rough rolling device 51 is provided in the rough rolling step. The rough rolling device 51 rolls the plate material M wound in the shape of a coil while feeding the plate material, and winds the contour molding material C, which is formed by the rolling, in the shape of a coil.

As shown in FIG. 1, the rough rolling device 51 includes an uncoiler (feed mechanism) 52, a rolling mill 53, a recoiler (winding mechanism) 54, a material pressing mechanism 55, and a speed adjusting mechanism 56. The uncoiler 52 feeds the plate material M, which is wound in the shape of a coil, by a predetermined amount. The rolling mill 53 rolls the plate material M into a contour molding material C while pressing the plate material M, which is fed from the uncoiler 52, in the thickness direction. The recoiler 54 winds the contour molding material C, which is formed by the rolling mill 53, at a constant speed. The material pressing mechanism 55 is provided between the uncoiler 52 and the rolling mill 53, and presses the plate material M. The speed adjusting mechanism 56 is provided between the rolling mill 53 and the recoiler 54, and pulls the contour molding material C while absorbing a difference in speed between the rolling mill 53 and the recoiler 54.

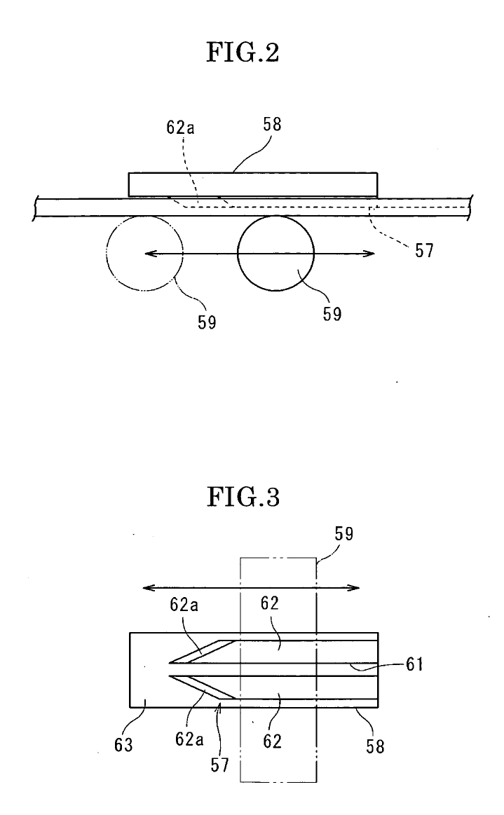

As shown in FIG. 2, the rolling mill 53 includes a plate die 58 that has a corrugated surface forming a molding surface 57, and a rolling roller 59 that faces the molding surface 57 of the die 58 and is reciprocated along the molding surface 57.

As shown in FIG. 3, a groove portion 61 for forming the thick portion y of the contour molding material C and protruding portions 62 for forming the thin portions m are formed on the molding surface 57 of the die 58 so as to be lined up. In the example shown in the drawing, two protruding portions 62, which are parallel to the feeding direction of the plate material M, are formed parallel to each other on a flat plate portion 63 so that a gap is formed between the protruding portions in a direction orthogonal to the feeding direction. The groove portion 61 is formed between the protruding portions 62 in a linear shape so as to be parallel to the feeding direction of the plate material M. Further, the greater part of each of both the protruding portions 62 is formed so as to have a constant width. However, the end face of each of the protruding portions, which faces the upstream side in the feeding direction, is formed of an inclined face 62a so that the width of the protruding portion is gradually decreased toward the tip of the protruding portion. Furthermore, the inclined face 62a is also inclined with respect to the upper surface of the flat plate portion 63. A sharp end is formed by both the protruding portions 62, and sharp ends are also formed by inclined faces 62a and side surfaces 61a that face the groove portion 61, respectively. The protruding portions are lined up in the direction orthogonal to the feeding direction so that the sharp end face the upstream side in the feeding direction of the plate material M. Moreover, as shown in FIG. 2, the die 58 is held so that the molding surface 57 faces the lower side.

Meanwhile, the axis of the rolling roller 59 is directed to the direction orthogonal to the feeding direction of the plate material M. As shown by arrows of FIGS. 1 to 3, the rolling roller is disposed at a position below the molding surface 57 of the die 58, passes through a position facing the molding surface 57, and is reciprocated in the feeding direction of the plate material M on the upstream side of the die 58 between a position that is deviated from the molding surface 57 and shown by a chain line and the position of the downstream end of the molding surface 57 of the die 58.

Further, when the rolling roller 59 is disposed at the upstream position of the die 58, the plate material M is fed between the molding surface 57 of the die 58 and the rolling roller 59. Then, the rolling roller 59 is moved along the molding surface 57 of the die 58 toward the downstream side, so that the plate material M is pressed against and made to bite into the molding surface 57 of the die 58. Accordingly, one surface of the plate material M is molded so as to correspond to the molding surface 57. Further, if being moved to the position of the downstream end of the die 58, the rolling roller 59 is moved again to the upstream position that is deviated from the molding surface 57 of the die 58. When the rolling roller 59 is disposed at the upstream position deviated from the molding surface 57 of the die 58, the plate material M is fed only by a predetermined pitch by the speed adjusting mechanism 56 as described below. Furthermore, the same operation is repeated and the rolling roller 59 is reciprocated, so that the plate material M is molded by the molding surface 57 of the die 58.

If the rolling roller 59 is reciprocated along the molding surface 57 of the die 58 while the plate material M is intermittently fed by a predetermined pitch in this way, there is obtained a contour molding material C where the thick portion y formed by the groove portion 61 of the die 58 and the thin portions m formed by the protruding portions 62 are continuously formed on the plate material M. As shown in FIG. 10 by a chain line, the thick portion y of the contour molding material C is formed so as to have substantially the same shape as the thick portion of the final contour strip G, but the thin portion m thereof is formed so as to have a width larger than the width of the thin portion of the final contour strip G. Side edge portions of the thin portions m are cut off in the following rolling step.

The material pressing mechanism 55 clamps the plate material M at the upstream position of the rolling mill 53 as shown in FIG. 1, so that the material pressing mechanism applies a braking friction force to the plate material M while suppressing the vibration of the plate material M. Further, brake members 65, which come into contact with both surfaces of the plate material M over a predetermined length, are pressed from the back side by fluid pressure such as air pressure.

The speed adjusting mechanism 56 adjusts a difference in speed between the intermittent feeding and the winding of the recoiler 54 at a constant speed by pulling and intermittently feeding the contour molding material C that is rolled by the rolling mill 53, and bending the middle portion of the contour molding material. Specifically, the speed adjusting mechanism includes a pair of support rollers 66 that is disposed with a gap therebetween in the feeding direction of the contour molding material C and comes into contact with the lower surface of contour molding material C, an oscillation roller 67 that comes into contact with the upper surface of the contour molding material C between the support rollers 66, and a spring 68 that pushes the oscillation roller 67 down from above. Further, when the oscillation roller 67 pushes the contour molding material C down from above, the contour molding material C is bent between the support rollers 66. When the rolling mill 53 carries out rolling (when the contour molding material C is stopped at the rolling mill 53), the bent portion of the contour molding material C between the support rollers 66 is pulled by the winding force of the recoiler 54. Accordingly, the oscillation roller 67 is moved up so as to reduce the length of the bent portion. Therefore, when the rolling roller 59 is disposed at an upstream position deviated from the molding surface 57 of the die 58, the contour molding material C (the plate material M) is intermittently fed only by a predetermined pitch from the rolling mill 53 until the oscillation roller 67 is pushed down by the pressing force of the spring 68 so as to increase the length of the bent portion of the contour molding material C between the support rollers 66 and the rolling roller 59 is moved to make the plate material M bite into the molding surface 57 of the die 58.

Meanwhile, in the example shown in FIG. 1, two support rollers 66 have been provided below the contour molding material C. However, one support roller 66 may be formed of a stationary support roller, and the other support roller may be supported by a spring like the oscillation roller so that a pressing force is applied to the contour molding material C.

In the speed adjusting mechanism 56, the spring 68 applies predetermined tension to the contour molding material C by pressing the oscillation roller 67. However, this tension is set to be smaller than the tension caused by the winding of the recoiler 54 so as not to obstruct the winding of the recoiler 54 at a constant speed. Meanwhile, the push-down force of the spring 68 allows a pulling force, which intermittently feeds the contour molding material C, to be applied to the contour molding material against the braking friction force of the material pressing mechanism 55.

In this case, the intermittent feeding of the contour molding material C, which is carried out by the speed adjusting mechanism 56, has been synchronized with the reciprocation of the rolling roller 59 of the rolling mill 53. However, it is preferable that the variation of tension, which is applied to the contour molding material C by the oscillation roller 67, be small in terms of the excellent accuracy of molding. For this reason, the spring constant of the spring 68 pressing the oscillation roller 67 is set to be large, and the natural frequency of the oscillation roller 67 is set to be increased with respect to the frequency of the rolling roller 59. Specifically, assuming that the natural frequency of the oscillation roller 67 is f1 and the frequency of the rolling roller 59 is f2, f1 is set to exceed f2 and be equal to or smaller than two times of f2.

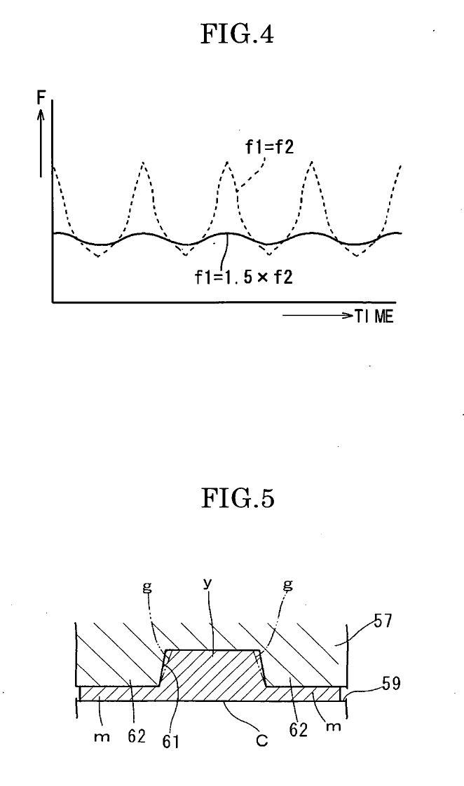

If the natural frequency f1 of the oscillation roller 67 corresponds to the frequency f2 of the rolling roller 59 (f1=f2), resonance occurs as shown by a broken line of FIG. 4 and a tensile load F applied to the plate material M significantly varies. For this reason, when rolling is carried out by the die 58, the groove portion 61 of the molding surface 57 is not sufficiently filled with a material and underfill portions are formed in the groove portion 61 as shown in FIG. 5 by a chain line g. Accordingly, there is a problem in that a portion between the thin portion m and the side surface of the thick portion y in the contour molding material C is not formed with a predetermined dimension and shape. The natural frequency f1 of the oscillation roller 67 is set in the range of “f2<f1≦(2×f2)”, so that an example where f1 is set to 1.5 times f2 is shown by, for example, a solid line of FIG. 4. However, the variation of a tensile load applied to the plate material M is decreased. As a result, the groove portion 61 of the molding surface 57 is sufficiently filled with a material, so that the thick portion y is formed to have accurate dimensions and shape.

For example, if the reciprocating frequency f2 of the rolling roller 59 is set to 300 times per minute, the natural frequency f1 of the oscillation roller 67 is set to be equal to the reciprocating frequency f2 of the rolling roller 59 (300 per minute=5 per second), and the weight of the oscillation roller 67 is 10 kg, the spring constant is about 1.0. However, if the natural frequency f1 of the oscillation roller 67 is set to 1.5 times the reciprocating frequency f2 of the rolling roller 59, the spring constant is about 2.4. If the spring constant of the spring 68 connected to the oscillation roller 67 is set to be larger than a value calculated from the frequency f2 of the rolling roller 59 as described above, the thick portion y and the thin portions m can be molded with highly accurate dimensions and a highly accurate shape.

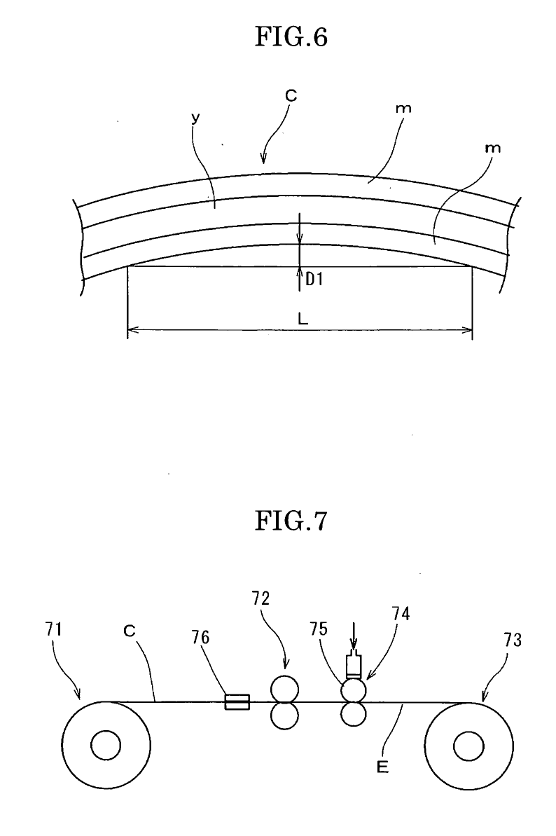

Further, assuming that the deviation of plate thickness at the thin portion m of the contour molding material C from a target value t is Δt (mm), an actual measurement of the radius of curvature at a corner formed by the side surface and the top surface of the thick portion y is e (mm), and an actual measurement of curvature (the degree of meandering) per meter-length of the contour molding material C is D1 (mm) (see FIGS. 6 and 10), Δt, e, and D1 are managed in the rough rolling step so as to be 0.01 or less, 0.15 or less, and 0.4 or less, respectively, and a rough rolling management value X determined by Δt×e×D1 is managed so as to be 5×10⁻⁴ or less.

Here, the curvature is the maximum displacement between a straight line and the side edge when two points, which are apart from each other by 1 meter along the side edge that forms the inside of a bend, are connected to each other by the straight line as shown in FIG. 6.

It may be possible to obtain a contour molding material C having a high accuracy by managing the rough rolling management value X, which is defined by the product of Δt, e, and D1, at a more accurate value while managing the deviation Δt of plate thickness at the thin portions m, the radius e of curvature at a corner, and the curvature D1, respectively. In addition, since the curvature D affects the width dimension (|A−B|) of the thin portion in the following slitting step, it may be possible to improve the slitting accuracy in the following step by managing the curvature in the rough rolling step.

### <Annealing Step>

In the annealing step, oil is removed from the contour molding material C by heating the contour molding material C so that oil adhering to the contour molding material C is vaporized. Then, the contour molding material C is heated up to 600° C. in, for example, a nitrogen gas atmosphere, and is cooled.

### <Finishing Rolling Step>

In the finishing rolling step, while the contour molding material C, which is molded by the rough rolling step, is fed at a constant speed, the corrugated surface formed on the surface of the contour molding material C is gradually pressed and formed by a roller (not shown) that is formed in the shape of the surface of the thick and thin portions y and m.

### <Slitting Step>

As shown in FIG. 7, in the slitting step, a contour slit material E is cut from the contour molding material C by an uncoiler (feed mechanism) 71, a slitter 72, a recoiler 73, and a tension control mechanism 74, and is wound at a constant speed in the shape of a coil. The uncoiler 71 feeds the contour molding material C, which is wound in the shape of a coil, by a predetermined amount. The slitter 72 cuts off the side edge portion of the thin portion m of the contour molding material C that is fed from the uncoiler 71. The recoiler 73 winds the cut contour slit material E. The tension control mechanism 74 controls the tension while pressing the contour slit material E between the slitter 72 and the recoiler 73.

The tension control mechanism 74 adjusts the tension between the contour slit material E and the recoiler 73 by pressing rollers 75, which come into contact with both surfaces of the contour slit material E, by fluid pressure such as air pressure, or the like. Reference numeral 76 of FIG. 7 denotes a guide that guides the position of the contour molding material C to the slitter 72 in the width direction.

Both side portions, which are shown in FIG. 10 by a chain line, are cut off by the slitting step, and thin portions m are formed on both sides of the thick portion y like the substantially final contour strip G. Further, assuming that an actual measurement of a difference between the width dimensions A and B of both the thin portions m is |A−B| (mm), |A−B| is managed so as to be 0.08 or less.

The slitting step is not a final step, and the final contour strip G is obtained through the next stretching step. However, it may be possible to improve the accuracy of the shape and dimensions of the final contour strip G by managing the width dimension |A−B| in the slitting step.

### <Stretching Step>

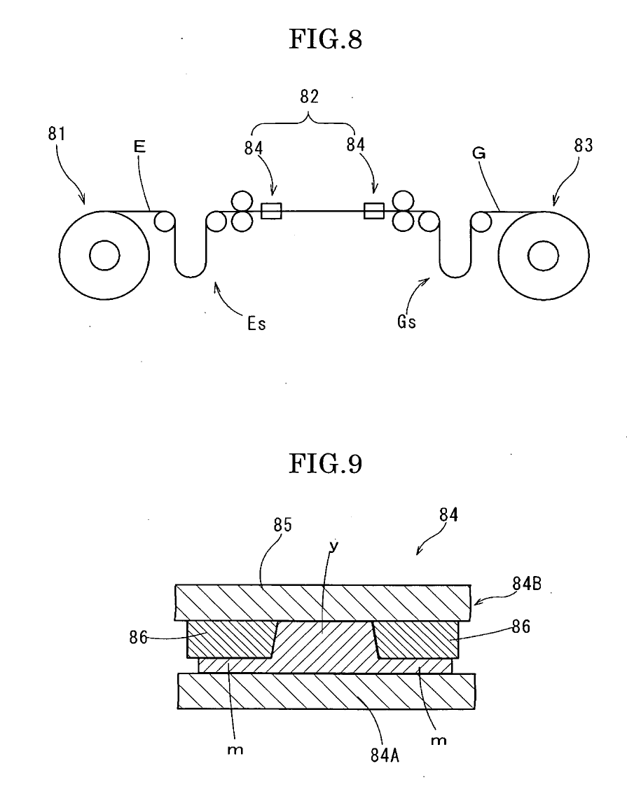

As shown in FIG. 8, an uncoiler (feed mechanism) 81, a stretching mechanism 82, and a recoiler (winding mechanism) 83 are used in the stretching step. The uncoiler 81 feeds the coil of the contour slit material E, which has been wound in the previous slitting step, at a constant speed. The stretching mechanism 82 forms an intended contour strip G by applying predetermined tension to the contour slit material E that has been fed. The recoiler 83 winds the contour strip G, which has passed through the stretching mechanism 82, at a constant speed. In this case, while the contour slit material E and the contour strip G form slack portions Es and Gs between the uncoiler 81 and the stretching mechanism 82 and between the stretching mechanism 82 and the recoiler 83 for the adjustment of tension, the contour slit material E and the contour strip G are supported.

The stretching mechanism 82 clamps the contour slit material E by clamp members 84 at two positions with a gap therebetween in a longitudinal direction, and applies predetermined tension to the contour slit material E by moving the clamp members 84 so that the clamp members become distant from each other in the longitudinal direction of the contour slit material E. Accordingly, the final contour strip G is formed. As shown in FIG. 9, the clamp member 84 includes a clamp member 84A that comes into contact with the lower surface of the contour slit material E, and a clamp member 84B that comes into contact with upper surface (corrugated surface) of the contour slit material E. The clamp member 84A is made of hard rubber and is formed in the shape of a flat plate. The clamp member 84B is formed by fixing convex parts 86, which come into contact with the upper surfaces of the thin portions m and are made of soft rubber, to a flat plate portion 85 that comes into contact with the top surface of the thick portion y and is made of hard rubber.

Meanwhile, the slack portions Es and Gs have been formed on both sides of the stretching mechanism 82 in the example shown in FIG. 8, but only one of the slack portions may be formed.

Assuming that an actual measurement of curvature (the degree of meandering) per meter-length of the contour strip G measured by the same measuring method as the method for measuring D1 shown in FIG. 6 is D2 (mm), D2 is managed in the stretching step so as to be 0.13 or less.

Further, assuming that |A−B| measured in the slitting step is a slitting management value Y and D2 measured in the stretching step is a stretching-management value Z, as the determination of whether the final contour strip G is an acceptable strip or a rejected strip, the final contour strip is determined as an acceptable strip if the product (X×Y×Z) of the rough rolling management value X, the slitting management value Y, and the stretching-management value Z is 6×10⁻⁶ or less. The final contour strip is determined as a rejected strip if the product is outside this range.

An intended contour strip G is obtained through the above-mentioned respective steps. Further, in the rough rolling step, the dimensions Δt, e, and D1 of the respective portions of the contour molding material C are managed, respectively, and the rough rolling management value X, which is obtained by the combination of the dimensions, is managed so as to be in a predetermined range. While the difference |A−B| between the width dimensions of the thin portions m is managed in the slitting step and the curvature D2 of the contour strip G is managed in the stretching step, the product (X×Y×Z) of the rough rolling management value X, the slitting management value Y, and the stretching-management value Z is finally managed and whether the final contour strip is an acceptable strip or a rejected strip is determined in this production process.

It may be possible to obtain a contour strip G having a high accuracy by setting and managing items to be managed, which are obtained by the combination of these measurements, in addition to managing the respective measurements, as described above. That is, if the management value obtained by the combination of these measurements is deviated from a desired management range even though each of the measurements is in the management range thereof, a contour strip is determined as a rejected strip. Conversely, it may be possible to obtain a contour strip having a high accuracy on the whole while easily managing the respective items by setting the management range to a slightly large range based on the idea that the close management using the management value obtained by the combination makes it possible to compensate the accuracy of each of the measurements by the accuracy of the other items to be managed. Further, it may be possible to efficiently manage the items.

Moreover, in that case, it may be possible to finish an end product with a very high accuracy by managing the curvature, which affects the width dimension of the thin portion m of the final contour strip G, in both the rough rolling step and the stretching step.

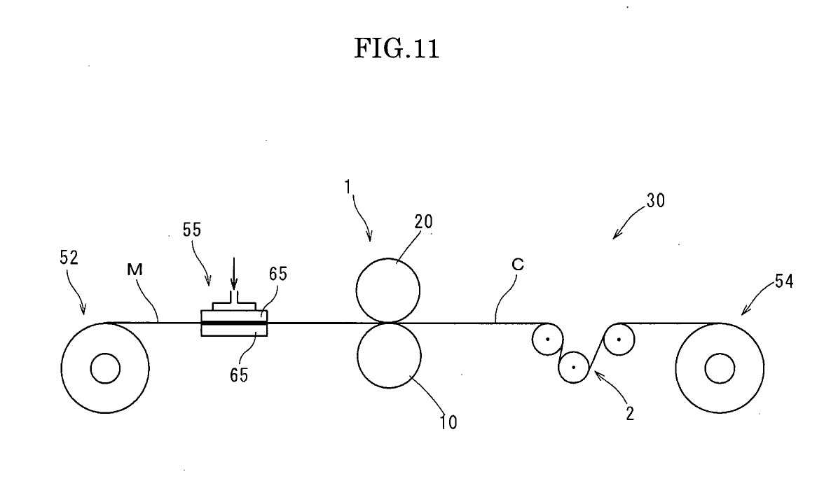

Next, a second embodiment of the invention will be described with reference to FIGS. 11 to 18.

Like the first embodiment, the second embodiment also includes a rough rolling step, an annealing step, a finishing rolling step, a slitting step, and a stretching step. In this case, the second embodiment is different from the first embodiment in that shaping using rollers is carried out in the rough rolling step, and the second embodiment is substantially the same as the first embodiment in terms of the subsequent steps between the annealing step and the stretching step. Accordingly, the rough rolling step will be described in detail.

Further, FIG. 18 shows a contour strip E that is finally obtained. A plurality of thick and thin portions y and m is alternately lined up on both sides of a thin portion m formed at the middle position in a width direction and the thick portions y are formed at both side edge portions so that the contour strip E includes five thin portions m and six thick portions y. Furthermore, the width of the thin portion m that is formed at the middle position in the width direction, and the widths of thin portions m that come into contact with the thick portions y formed at both the side edge portions are set to be smaller than the width of the other thin portion m. The widths of the thick portions y, which are adjacent to both sides of the thin portion m formed at the middle position, are also set to be smaller than the width of the other thick portion y. Moreover, the widths of the thick portions y, which are formed at the side edge portions, are set to the same width (A=B). The thicknesses t of the respective thin portions m are equal to each other. Other than these, although not shown, the second embodiment is the same as the first embodiment in that the radius of curvature at a corner that is formed between the upper surface of each thin portion m and each side surface of the thick portion y, and the radius of curvature at a corner that is formed between each side surface and the top surface of the thick portion y are set to the same target value.

A rough rolling device 30, which produces a contour molding material in the rough rolling step, includes a rolling mill 1 that includes a flat roller 10 and a grooved roller 20 as shown in FIG. 11. Further, the second embodiment is the same as the first embodiment in that an uncoiler (feed mechanism) 52, a recoiler (winding mechanism) 54, and a material pressing mechanism 55 are provided. A tension adjusting mechanism 2 is provided between the rolling mill 1 and the recoiler 54.

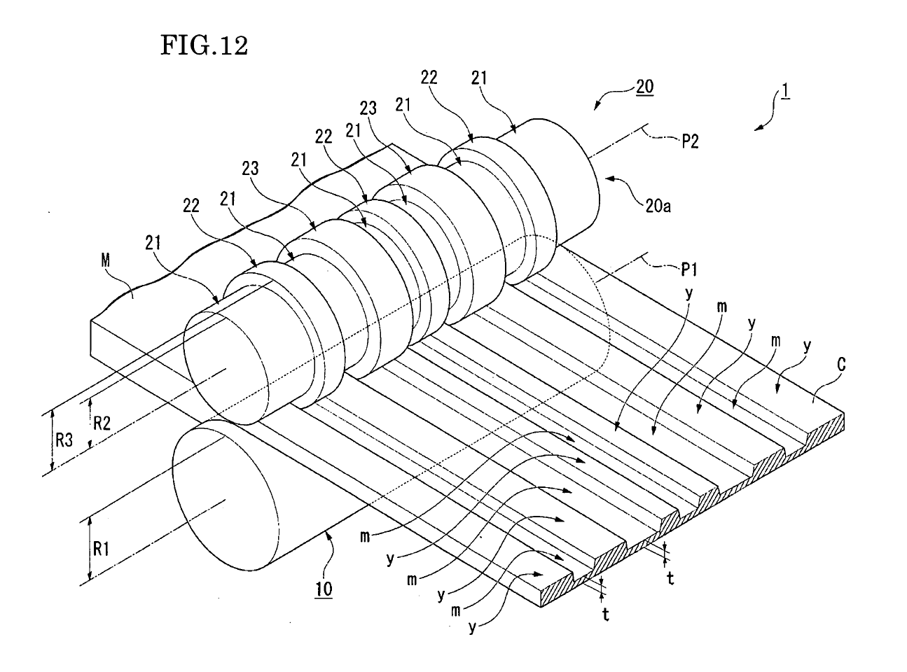

FIG. 12 shows main portions of the rolling mill 1. The flat roller 10 is a roller that is formed so as to have a constant roller radius R1 and does not include stepped portions on the outer peripheral portion thereof. The flat roller is disposed so that an axis P1 is horizontal. Meanwhile, the flat roller 10 is made of tool steel.

The grooved roller 20 includes three kinds (a plurality) of roller portions that have different roller radii and are formed on the outer peripheral portion 20a thereof. The grooved roller includes six small-diameter roller portions 21 for forming thick portions, three first large-diameter roller portions 22 having relatively small width, and two second large-diameter roller portions 23 having large width. Meanwhile, the grooved roller 20 is made of tool steel like the flat roller 10.

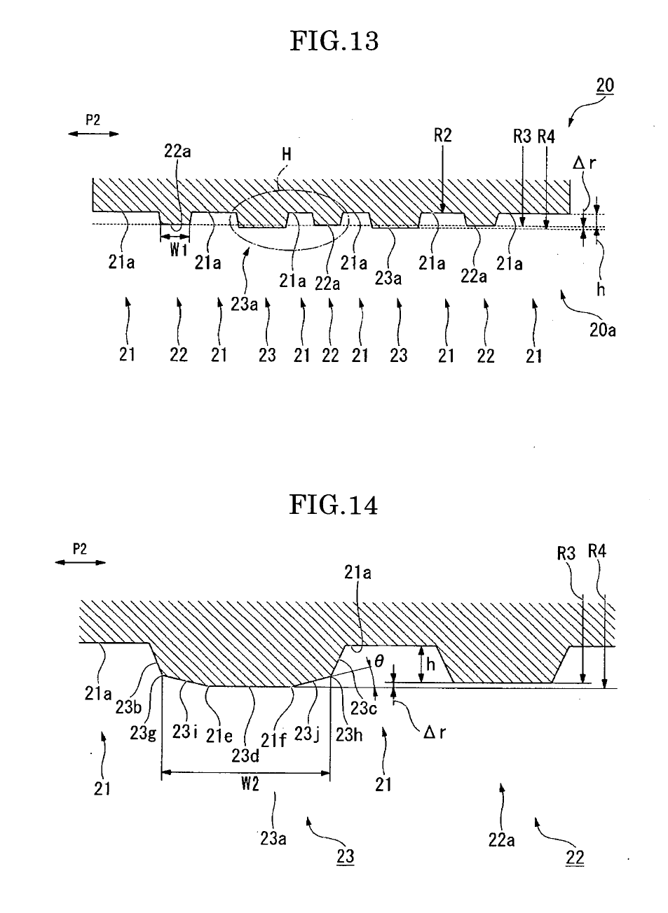

As shown in FIGS. 12 to 14, the small-diameter roller portion 21 is a portion that is formed to have the minimum roller radius R2 among the three kinds of roller radii, and six small-diameter roller portions are formed with a gap therebetween in the direction of an axis P2. Two of the small-diameter roller portions are formed at both end portions of the outer peripheral portion 20a. As shown in FIGS. 13 and 14, the outer peripheral surface 21a of each of the six small-diameter roller portions 21 extends parallel to the axis P2.

As shown in FIGS. 12 to 14, the first large-diameter roller portion 22 is a portion formed so as to have a roller radius R3 that is larger than the roller radius R2. The first large-diameter roller portions 22 are formed at the middle position on the outer peripheral portion 20a in the direction of the axis P2 and at two positions that are positioned on both sides of the middle position and distant from the middle position by the same gap. The first large-diameter roller portions 22 are adjacent to the small-diameter roller portions 21 at both the ends in the direction of the axis P2, respectively. As shown in FIGS. 13 and 14, the outer peripheral surfaces 22a of the three first large-diameter roller portions 22 extend parallel to the axis P2 by a roller width W1 at positions that protrude from the outer peripheral surfaces 21a of the small-diameter roller portions to the outside in the radial direction by a height h, respectively. Meanwhile, the roller width means a distance between both end edges of the roller portion in the direction of the axis.

In this embodiment, the height h is set to 0.4 mm, the roller width W of the first large-diameter roller portion 22 is set to 1.0 mm, and W1/h is set to 2.5.

As shown in FIG. 13, the second large-diameter roller portion 23 is a portion of which a part is formed so as to have a roller radius R4, the second large-diameter roller portions are formed between the three first large-diameter roller portions 22, respectively, and the second large-diameter roller portions 23 are adjacent to the small-diameter roller portions 21 at both ends in the direction of the axis P2 like the first large-diameter roller portion 22.

The profile of the longitudinal section of the second large-diameter roller portion 23, which is taken along a plane passing through the axis P2, includes two end faces 23b and 23c that form obtuse angles together with the outer peripheral surfaces 21a of the small-diameter roller portions 21, and an outer peripheral surface 23a that connects between the end faces 23b and 23c. A roller width W2 between end edge portions (corners) 23g and 23h of the second large-diameter roller portion 23, which are formed by the outer peripheral surface 23a and the end faces 23b and 23c, respectively, is set to 4 mm in this embodiment.

The outer peripheral surface 23a of the second large-diameter roller portion 23 includes a middle surface (middle portion) 23d that is formed at the middle position of the second large-diameter roller portion 23 in the direction of the axis P2, and tapered surfaces 23i and 23j that are formed from both ends (fixed positions) 23e and 23f of the middle surface 23d toward both the end edges 23g and 23h of the second large-diameter roller portion 23, respectively.

More specifically, the middle surface 23d is formed to have the roller radius R4 and extends in the direction of the axis P2. The tapered surfaces 23i and 23j extend so as to decrease a roller radius from both the ends 23e and 23f of the middle surface 23d to both the end edges 23g and 23h and so as to be symmetric with respect to the middle surface 23d.

As described above, the middle surface 23d of the second large-diameter roller portion 23 protrudes further outward in the radial direction of the grooved roller 20 by a difference Δr(R4−R3) as compared to the outer peripheral surface 22a of the first large-diameter roller portion 22, and is extended (see FIGS. 13 and 14).

In this embodiment, Δr is set to 0.06 mm. That is, a ratio Δr/h between the height h and the difference Δr between the roller radius R4 of the middle surface 23d and the roller radius R3 of the outer peripheral surface 22a is set to 0.15, and a ratio W2/h between the height h and the roller width W2 of the second large-diameter roller portion 23 is set to 10.

Further, an angle θ between each of the tapered surfaces 23i and 23j, which are formed at both end portions of the middle surface 23d, and the middle surface 23d (an angle between each of the tapered surfaces and the axis P2) is set in the range of 0.1 to 5°.

The grooved roller 20 having the above-mentioned structure is disposed close to the flat roller so that the axis P2 is parallel to the axis P1 of the flat roller 10 and a gap between the outer peripheral surface 22a of the first large-diameter roller portion 22 and the outer peripheral surface of the flat roller 10 is about 0.2 mm, that is, a gap between the outer peripheral surface 21a of the small-diameter roller portion 21 and the outer peripheral surface of the flat roller 10 is about 0.6 mm.

Next, a method for producing a contour molding material C, which forms a contour strip G, using the rough rolling device 30 having the above-mentioned structure will be described.

First, as shown in FIG. 12, a roller drive unit (not shown) drives the flat roller 10 and the grooved roller 20 that are stopped, and rotates the flat roller 10 and the grooved roller 20 so that the tangential components of velocity of portions of the rollers close to each other are parallel to the feeding direction of a plate material M.

At the same time, a material feeding unit (not shown) inserts a plate material M into a gap that is formed between the flat roller 10 and the grooved roller 20.

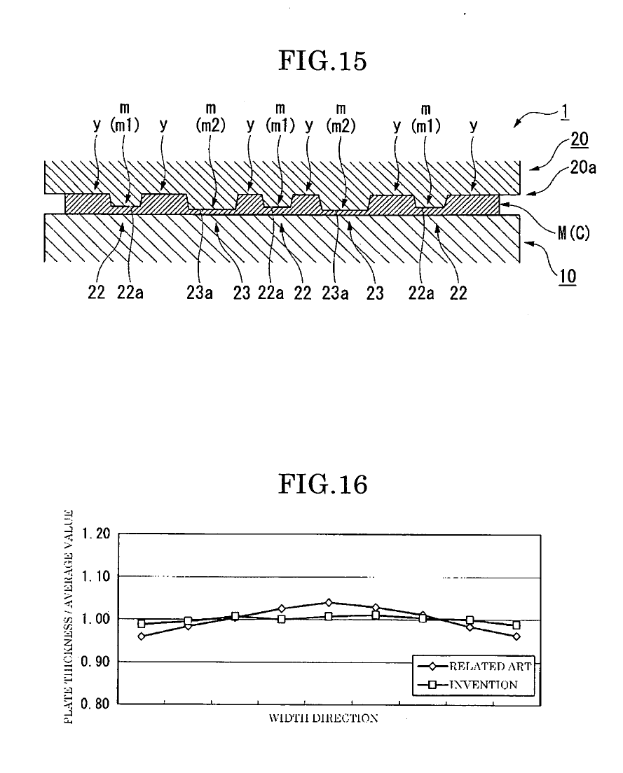

As shown in FIG. 15, the plate material M inserted into the gap between the flat roller 10 and the grooved roller 20 is rolled, so that stepped portions having different thicknesses in the width direction of the plate material M are formed on the surface of the plate material facing the grooved roller 20. That is, the plate material M is pressed by the first and second large-diameter roller portions 22 and 23, so that five thin portions m (m1 and m2) are formed on the plate material M and six thick portions y are formed between the respective thin portions.

The width of the thin portion m1 of the contour molding material C, which is formed by the pressing of the first large-diameter roller portion 22, is 1.0 mm which is substantially equal to the roller width W1 of the first large-diameter roller portion 22. Further, the depth of the thin portion m1 from the outer peripheral surface of the thick portion is 0.4 mm which is substantially equal to the height h, and the thin portion m1 has a relatively small width. During the rolling, the plate material M is elongated in the longitudinal direction (the insertion direction of the plate material M), and compressive stress is generated by a difference between the elongated length of a portion of the thin portion m1 close to the middle portion in the width direction and the elongated length of the thick portion y adjacent to the thin portion m1. However, since deformation is suppressed by the thick portions y formed on both sides, the thin portion m1 is molded so as to have a uniform thickness. Accordingly, the upper surface of the thin portion m1 is formed in a planar shape.

In contrast, as the width of the thin portion m2 of the contour molding material C, which is formed by the pressing of the second large-diameter roller portion 23, is increased, pressure per unit area applied to the surface of the thin portion m2 is decreased. Accordingly, the thin portion m2 is apt to be thick as compared to the thin portion formed by the first large-diameter roller portion 22 having a small width. Further, since the width of the thin portion is large, the middle portion of the thin portion in the width direction is far from the thick portions. For this reason, the suppression of the above-mentioned thick portions does not affect the middle portion of the thin portion, so that a portion of the thin portion close to the middle portion in the width direction is apt to be formed thick.

In this case, the protruding height (h+Δr) of the second large-diameter roller portion 23 from the outer peripheral surface 21a of the small-diameter roller portion 21 is larger than the protruding height (h) of the first large-diameter roller portion 22, and the middle portion in the width direction is formed high. Accordingly, the pressing distance of the second large-diameter roller portion 23 is larger than that of the first large-diameter roller portion 22 by Δr. In addition, since the pressing distance is gradually decreased toward the boundary portions between the second large-diameter roller portion 23 and the thick portions due to the tapered surface 23i and 23j, the molded thin portion has the same thickness as the thickness of the thin portion molded by the first large-diameter roller portion 22 and has a uniform thickness in the width direction. That is, the width of the thin portion is 4.0 mm which is substantially equal to the roller width W2 of the second large-diameter roller portion 23, and the depth of the thin portion from the outer peripheral surface of the thick portion is 0.4 mm which is substantially equal to the height h.

Accordingly, it may be possible to form the thin portion so that the thin portion has the same thickness as the thickness of the thin portion molded by any one of large-diameter roller portions 22 and 23.

In this way, the plate material M is rolled by the flat roller 10 and the grooved roller 20, so that a contour molding material C having a high dimensional accuracy is produced.

Meanwhile, like in the first embodiment, the deviation Δt of plate thickness t at the thin portion m from a target value, the radii e of curvature at a corner formed by the side surface and the top surface of the thick portion and at a corner formed by the upper surface of the thin portion and the side surface of the thick portion, and the curvature D1 per meter-length of the contour molding material C are managed in the rough rolling step so that Δt is 0.01 mm or less, e is 0.15 mm or less, and D1 is 0.4 mm or less. Further, the rough rolling management value X, which is the product of these values, is obtained, and the rough rolling management value X is managed so as to be 5×10⁻⁴ or less.

Moreover, the difference |A−B| between the widths of the thick portions of both the side edge portions is managed in the subsequent slitting step so as to be 0.08 mm or less. In this case, since the thick portions y formed on both sides are cut in the second embodiment, the difference |A−B| is obtained by the measurement results of the width dimensions A and B of the thick portions y (see FIG. 18). Further, the curvature D2 per meter-length of the contour strip G is managed in the stretching step so as to be 0.13 mm or less. Furthermore, the slitting management value Y of |A−B| and the stretching-management value Z of D2 are obtained and the product (X×Y×Z) of the rough rolling management value, the slitting management value, and the stretching-management value is managed so as to be 6×10⁻⁶ or less, so that a contour strip having a highly accurate shape and accurate dimensions is obtained.

As described above, according to the second embodiment, the pressing distance of the second large-diameter roller portion 23 becomes maximum at the middle surface 23d in the direction of the axis P2 and is gradually decreased toward both the end edges 23g and 23h from both the ends 23e and 23f of the middle surface 23d. Accordingly, even though the thickness of the middle portion of the thin portion m2 of the contour molding material C, which is pressed against the middle surface 23d, in the width direction is increased, it may be possible to form the thin portion m2 in a planar shape.

Therefore, it may be possible to work the upper surface of the thin portion m of the contour molding material C in a planar shape and to obtain excellent working accuracy.

In this way, it may be possible to appropriately select whether to form the outer peripheral surface of the roller portion having a uniform roller radius or to form the outer peripheral surface of the roller portion having different roller radii according to the widths and depths of the thin portions m (m1 and m2) of the contour molding material C, and to form the upper surfaces of the thin portions m (m1 and m2) in a planar shape. Specifically, if the width W of the thin portion satisfies “W/h≧3”, the thickness is difficult to increase at the middle portion in the width direction as in the case of the thin portion m1. Accordingly, it is preferable that the outer peripheral surface of the roller portion having a uniform roller radius be formed. Meanwhile, if “W/h3” is satisfied, the thickness is easy to increase at the middle portion in the width direction as in the case of the thin portion m2. Accordingly, it is preferable that the outer peripheral surface of the roller portion having different roller radii be formed.

Further, if a difference Δr/h between the roller radius R4 and the roller radius R3 is set in the range of 0.01 to 0.5, the depth of the thin portion m2 may be substantially equal to the height h.

Furthermore, since the roller radius of the outer peripheral surface 23a of the second large-diameter roller portion 23 is linearly decreased due to the tapered surfaces 23i and 23j in sectional view, it may be possible to easily form the second large-diameter roller portion 23.

Moreover, the tapered surfaces 23i and 23j are formed at the outer peripheral surface 23a of the second large-diameter roller portion 23 so as to be symmetric with respect to the middle surface 23d, and two small-diameter roller portions 21 are formed on both sides of the second large-diameter roller portion 23 so as to be adjacent to the second large-diameter roller portion. Accordingly, the pressing distance of the second large-diameter roller portion 23 in the direction of the axis P2 may be symmetric with respect to the middle surface 23d, and it may be possible to make the pressing distances of the two small-diameter roller portions 21, which are formed on both sides of the second large-diameter roller portion 23 so as to be adjacent to the second large-diameter roller portion, be equal to each other.

FIG. 16 is a view showing the measurement results of the thickness of a thin portion of a contour molding material in the width direction, in which a square plot represents the measurement results of the thin portion m2 formed by the second large-diameter roller portion 23 and a rhombic plot represents the measurement results of the thin portion formed by a roller portion in the related art (a roller portion having only the roller radius R3).

As shown in FIG. 16, thickness is increased at the middle portion of the thin portion in the width direction in the case of a grooved roller in the related art, but thickness is substantially constant in the width direction in the case of the second large-diameter roller portion 23.

Meanwhile, the operating procedure, the shapes of the respective components, the combination thereof, and the like described in the above-mentioned embodiments are illustrative. Therefore, various modifications may be made on the basis of design requests and the like without departing from the scope of the invention.

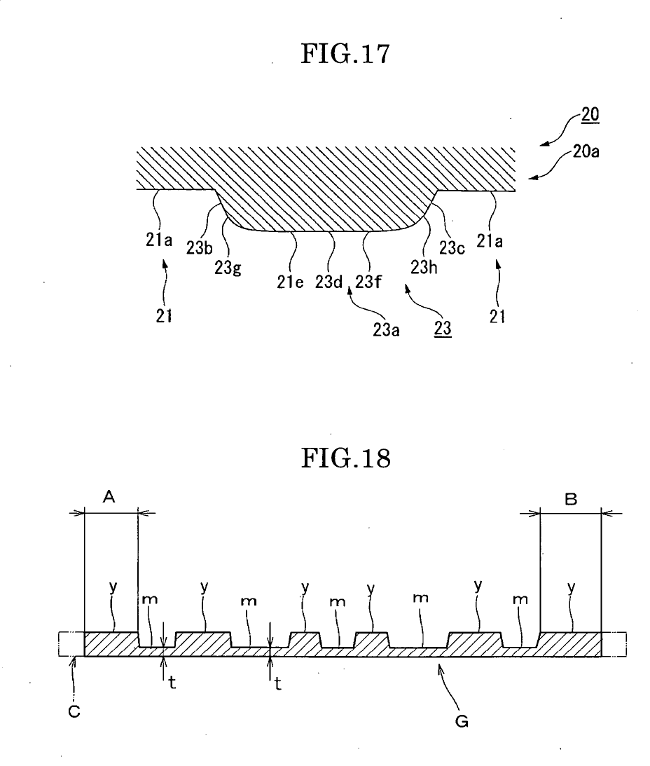

FIG. 17 is a view showing an example of modification of the outer peripheral surface 23a of the second large-diameter roller portion 23 according to the invention. Meanwhile, the same structures as those shown in FIGS. 12 to 15 are denoted by the same reference numerals and the description thereof will be omitted.

In the above-mentioned embodiments, the tapered surfaces 23i and 23j are formed so that a roller radius is changed to the roller radius R3 from the roller radius R4. However, as shown in FIG. 17, the roller radius of the second large-diameter roller portion may be gradually decreased from both ends 23e and 23f of the middle surface 23d toward both end edges 23g and 23h so that the second large-diameter roller portion is formed in an arc shape in cross-sectional view. It may be possible to obtain the same advantages as described above even when the second large-diameter roller portion is formed as described above.

Moreover, a copper alloy of Cu-0.1% Fe-0.03% P has been used as the plate material M in the above-mentioned embodiments. However, for example, a copper alloy (Cu-0.15% Sn-0.006% P, Cu-0.02% Zr, Cu-2.3% Fe-0.12% Zn-0.03% P, C1020 (oxygen-free copper), or C1220 (phosphorous-deoxidized copper)), which is a material having high conductivity, other than the copper alloy may be worked to good effect. Further, a copper alloy (Cu-0.7% Mg-0.005% P, Cu-0.5% Sn-1.0% Zn-2.0% Ni-0.5% Si, or Cu-0.3% Cr-0.1% Zr-0.02% Si), which is a material having high strength, may be worked to good effect.

Meanwhile, it is thought that the increase of the thickness of the thin portion of the contour molding material depends on not only the dimensions of the contour molding material but also the material of the contour molding material. That is, the values of the above-mentioned w/h and Δr/h are not limited to those of the above-mentioned embodiments, and are appropriately set according to the material of the contour molding material.

### INDUSTRIAL APPLICABILITY

The invention may be used as a technique that produces a contour strip used for a lead frame of a LED, a power transistor, or the like.

### REFERENCE SIGNS LIST

51 ROUGH ROLLING DEVICE
52 UNCOILER
53 ROLLING MILL
54 RECOILER
55 MATERIAL PRESSING MECHANISM
56 SPEED ADJUSTING MECHANISM
57 MOLDING SURFACE
58 DIE
59 ROLLING ROLLER
61 GROOVE PORTION
62 PROTRUDING PORTION
65 BRAKE MEMBER
66 SUPPORT ROLLER
67 OSCILLATION ROLLER
68 SPRING
72 SLITTER
73 RECOILER
74 TENSION ADJUSTING MECHANISM
75 ROLLER
81 UNCOILER
82 STRETCHING MECHANISM
83 RECOILER
84 CLAMP MEMBER
1 ROLLING MILL
10 FLAT ROLLER
20 GROOVED ROLLER
22 FIRST LARGE-DIAMETER ROLLER PORTION
23 SECOND LARGE-DIAMETER ROLLER PORTION
23d MIDDLE SURFACE (MIDDLE PORTION)
23e, 23f BOTH ENDS (FIXED POSITION)
23g, 23h BOTH END EDGES
30 ROUGH ROLLING DEVICE
M PLATE MATERIAL
C CONTOUR MOLDING MATERIAL
G CONTOUR STRIP

1. A method for producing a contour strip, the method comprising:
a rough rolling step for rolling a plate material to form a contour molding material where thick and thin portions are lined up in a width direction;
a slitting step for slitting the contour molding material in a longitudinal direction at the middle position in the width direction of the thick portion or the thin portion disposed at both side edge portions thereof and slitting off both side edge portions to form a contour slit material; and
a stretching step for stretching the contour slit material to obtain a contour strip,
wherein rolling is carried out in the rough rolling step so that Δt is 0.01 or less, e is 0.15 or less, D1 is 0.4 or less, and a rough rolling management value X determined by Δt×e×D1 is 5×10⁻⁴ or less, assuming that the deviation of plate thickness at the thin portion from a target value is Δt (mm), an actual measurement of the radius of curvature at a corner formed by the side surface and the top surface of the tick portion is e (mm), and an actual measurement of curvature per meter-length of the contour molding material is D1 (mm),
the contour molding material is cut in the slitting step so that |A−B| is 0.08 or less assuming that an actual measurement of the difference in the width from the side edge of the thick portion or the thin portion disposed at both side edge portions is |A−B| (mm), and
the contour slit material is stretched in the stretching step so that D2 is 0.13 or less assuming that an actual measurement of curvature per meter-length of the contour strip is D2 (mm).

2. The method according to claim 1,
wherein the contour strip is produced so that the product (X×Y×Z) of a rough rolling management value X, a slitting management value Y, and a stretching-management value Z is 6×10⁻⁶ or less assuming that |A−B| measured in the slitting step is the slitting management value Y and D2 measured in the stretching step is the stretching-management value Z.

3. The method according to claim 2,
wherein in the rough rolling step, the plate material is intermittently fed in the longitudinal direction by a die that includes a molding surface for forming the thick and thin portions and a rolling roller that is reciprocated in the longitudinal direction of the molding surface of the die between a position facing the molding surface of the die and a position deviated from the molding surface of the die, when the rolling roller is positioned at the position deviated from the molding surface of the die, and the plate material is interposed between the rolling roller and the molding surface of the die and is rolled when the rolling roller is positioned at a position facing the molding surface of the die.

4. The method according to claim 3,
wherein in the rough rolling step, brake members, which come into contact with the plate material at the upstream position of the die, are pressed and apply a braking friction force to the plate material while the contour molding material is wound at a constant speed at the downstream position of the die by a winding mechanism, and the contour molding material is pulled while being bent by pressing an oscillation roller, which comes into contact with the other surface of the contour molding material by a spring while one surface of the contour molding material is supported by support rollers between the die and the winding mechanism.

5. The method according to claim 4,
wherein assuming that the natural frequency of the oscillation roller, which is pressed by the spring, is f1 and the frequency of the rolling roller is f2, a spring constant of the spring is determined so that f1 exceeds f2 and is equal to or smaller than twice f2.

6. The method according to claim 2,
wherein in the rough rolling step, the plate material is interposed and rolled between a grooved roller on which small-diameter roller portions for forming the thick portions and large-diameter roller portions for forming the thin portions are formed to be lined up in the direction of an axis, and a flat roller that has a constant radius in the direction of an axis.

7. The method according to claim 6,
wherein the grooved roller is formed so that wide large-diameter roller portions and narrow large-diameter roller portions narrower than the wide large-diameter roller portions are formed to be lined up with small-diameter roller portions interposed therebetween, the diameter of the wide large-diameter roller portion is larger than that of the narrow large-diameter roller portion, and Δr/h is in the range of 0.01 to 0.5 assuming that a difference between the radii of both the large-diameter roller portions is Δr and a difference between the radii of the narrow large-diameter roller portion and the small-diameter roller portion is h.

8. The method according to claim 1,
wherein in the slitting step, tension is controlled by pressing the respective contour slit materials between the winding mechanism and the slitter while the respective contour slit materials separated by the slitter are wound at a constant speed by the winding mechanism.

9. The method according to claim 1,
wherein in the stretching step, the stretched contour strip is wound at a constant speed by a winding mechanism while the contour slit material is fed at a constant speed by a feed mechanism,
the contour slit material is intermittently fed by an intermittent feeding mechanism while slack portions are formed at the contour slit material and the contour strip between the feed mechanism and the winding mechanism, and
the thick and thin portions of the contour slit material, which is intermittently fed, are pressed by elastic members.

10. The method according to claim 2,
wherein in the slitting step, tension is controlled by pressing the respective contour slit materials between the winding mechanism and the slitter while the respective contour slit materials separated by the slitter are wound at a constant speed by the winding mechanism.

11. The method according to claim 3,
wherein in the slitting step, tension is controlled by pressing the respective contour slit materials between the winding mechanism and the slitter while the respective contour slit materials separated by the slitter are wound at a constant speed by the winding mechanism.

12. The method according to claim 4,
wherein in the slitting step, tension is controlled by pressing the respective contour slit materials between the winding mechanism and the slitter while the respective contour slit materials separated by the slitter are wound at a constant speed by the winding mechanism.

13. The method according to claim 5,
wherein in the slitting step, tension is controlled by pressing the respective contour slit materials between the winding mechanism and the slitter while the respective contour slit materials separated by the slitter are wound at a constant speed by the winding mechanism.

14. The method according to claim 6,
wherein in the slitting step, tension is controlled by pressing the respective contour slit materials between the winding mechanism and the slitter while the respective contour slit materials separated by the slitter are wound at a constant speed by the winding mechanism.

15. The method according to claim 7,
wherein in the slitting step, tension is controlled by pressing the respective contour slit materials between the winding mechanism and the slitter while the respective contour slit materials separated by the slitter are wound at a constant speed by the winding mechanism.

16. The method according to claim 2,
wherein in the stretching step, the stretched contour strip is wound at a constant speed by a winding mechanism while the contour slit material is fed at a constant speed by a feed mechanism,
the contour slit material is intermittently fed by an intermittent feeding mechanism while slack portions are formed at the contour slit material and the contour strip between the feed mechanism and the winding mechanism, and
the thick and thin portions of the contour slit material, which is intermittently fed, are pressed by elastic members.

17. The method according to claim 3,
wherein in the stretching step, the stretched contour strip is wound at a constant speed by a winding mechanism while the contour slit material is fed at a constant speed by a feed mechanism,
the contour slit material is intermittently fed by an intermittent feeding mechanism while slack portions are formed at the contour slit material and the contour strip between the feed mechanism and the winding mechanism, and
the thick and thin portions of the contour slit material, which is intermittently fed, are pressed by elastic members.

18. The method according to claim 4,
wherein in the stretching step, the stretched contour strip is wound at a constant speed by a winding mechanism while the contour slit material is fed at a constant speed by a feed mechanism,
the contour slit material is intermittently fed by an intermittent feeding mechanism while slack portions are formed at the contour slit material and the contour strip between the feed mechanism and the winding mechanism, and
the thick and thin portions of the contour slit material, which is intermittently fed, are pressed by elastic members.

19. The method according to claim 5,
wherein in the stretching step, the stretched contour strip is wound at a constant speed by a winding mechanism while the contour slit material is fed at a constant speed by a feed mechanism,
the contour slit material is intermittently fed by an intermittent feeding mechanism while slack portions are formed at the contour slit material and the contour strip between the feed mechanism and the winding mechanism, and
the thick and thin portions of the contour slit material, which is intermittently fed, are pressed by elastic members.

20. The method according to claim 6,
wherein in the stretching step, the stretched contour strip is wound at a constant speed by a winding mechanism while the contour slit material is fed at a constant speed by a feed mechanism,
the contour slit material is intermittently fed by an intermittent feeding mechanism while slack portions are formed at the contour slit material and the contour strip between the feed mechanism and the winding mechanism, and
the thick and thin portions of the contour slit material, which is intermittently fed, are pressed by elastic members.
